(19) United States
(12) Patent Application Publication
(10) Pub. No.: US 2026/0196817 A1
(43) Pub. Date: Jul. 9, 2026

(54) IN-GROUND UTILITY ACCESS BOX AND RELATED METHODS

(71) Applicant: American Polymer Company, Pompano Beach, FL (US)

(72) Inventors: Pedro Perez, San Antonio, TX (US); Sean Dvoran, Pompano Beach, FL (US)

(21) Appl. No.: 19/556,467

(22) Filed: Mar. 4, 2026

Related U.S. Application Data
(63) Continuation-in-part of application No. 18/797,983, filed on Aug. 8, 2024.
(60) Provisional application No. 63/518,915, filed on Aug. 11, 2023.

(51) Int. Cl. H02G 9/00

(52) U.S. Cl. CPC H02G 9/00

(57) ABSTRACT

A utility access system may include a utility access vault having a base, a plurality of sidewalls extending vertically upward from the base and connected together to define a cavity therein with an opening at a top thereof and a rim inside the opening. The system may also include a reversible cover configured to at least partially close the opening when received by the rim. The reversible cover may comprise a body having a first side and a second side, with the first side including a first mounting pattern corresponding to a first pedestal type, the second side including a second mounting pattern corresponding to a second pedestal type, and the second mounting pattern being different from the first mounting pattern. The reversible cover may be selectively positionable with either the first side facing upward to expose the first mounting pattern or the second side facing upward to expose the second mounting pattern.

### RELATED APPLICATIONS

This application is a continuation-in-part of U.S. application Ser. No. 18/797,983 filed Aug. 8, 2024, which claims the benefit of U.S. provisional application No. 63/518,915 filed Aug. 11, 2023, both of which are hereby incorporated herein in their entireties by reference.

### TECHNICAL FIELD

The present disclosure generally relates to utility infrastructure, and more particularly to access boxes for utility infrastructure components and related methods.

### BACKGROUND

Various types of ground boxes or vaults are used to provide access points in a number of utility infrastructure applications. For example, pull boxes provide access to cables such as electrical or telecommunications lines. Other similar types of boxes provide access to valves, meters, and the like.

Such boxes are typically buried with the top of the box flush with the ground. A removable lid provides access to the infrastructure within when needed, and keeps the infrastructure otherwise closed off and protected when it is not. Various materials are used for such boxes, including concrete and polymer-based materials, for example.

### SUMMARY

A utility access system may include a utility access vault having a base, a plurality of sidewalls extending vertically upward from the base and connected together to define a cavity therein with an opening at a top thereof and a rim inside the opening. The system may also include a reversible cover configured to at least partially close the opening when received by the rim. The reversible cover may comprise a body having a first side and a second side, with the first side including a first mounting pattern corresponding to a first pedestal type, the second side including a second mounting pattern corresponding to a second pedestal type, and the second mounting pattern being different from the first mounting pattern. The reversible cover may be selectively positionable with either the first side facing upward to expose the first mounting pattern or the second side facing upward to expose the second mounting pattern.

In an example embodiment, the body has a cable opening therein, and the first and second mounting patterns are positioned around the cable opening. By way of example, the first and second mounting patterns may be centered on the cable opening. The body may have a peripheral rim portion configured to rest on the rim of the utility access vault. In some embodiments, the body of the reversible cover may comprise a unitary body, and it may comprise high-density polyethylene (HDPE), for example.

In an example implementation, each of the sidewalls of the utility access vault may include a plurality of first and second ribs extending from the base to the rim, with the first ribs extending outwardly away from the rim and the second ribs extending inwardly toward the rim. Moreover, the first and second ribs may be arranged in an alternating fashion along each sidewall. By way of example, the first and second ribs may comprise elongated isosceles trapezoids. Furthermore, the utility access vault may include a plurality of interior support members coupled between interior surfaces of the utility access vault and a bottom of the rim.

A related reversible pedestal cover for a utility access vault may include a body having a first side and a second side and including a peripheral rim portion configured to rest on a rim of the utility access vault. The cover may also include a first mounting pattern on the first side of the body corresponding to a first pedestal type, and a second mounting pattern on the second side of the body and corresponding to a second pedestal type, the second mounting pattern being different from the first mounting pattern. The body may be reversible to selectively expose either the first mounting pattern or the second mounting pattern.

A related method for installing a pedestal on a utility access vault may include positioning the utility access vault, such as the one described briefly above, at a utility access point. The method may further include providing a reversible cover configured to at least partially close the opening, with the reversible cover comprising a body having a first side and a second side, the first side including a first mounting pattern corresponding to a first pedestal type, and the second side including a second mounting pattern corresponding to a second pedestal type. Moreover, the second mounting pattern may be different from the first mounting pattern. The method may further include selectively positioning the reversible cover on the rim with either the first side facing upward to expose the first mounting pattern or the second side facing upward to expose the second mounting pattern based upon the pedestal being of the first or second pedestal type, respectively, and securing the pedestal to the upward facing side of the reversible cover.

### BRIEF DESCRIPTION OF THE DRAWINGS

FIG. 1 is a top perspective view of a utility access box in accordance with an example embodiment.

FIG. 2 is a side view of the utility access box of FIG. 1.

FIG. 3 is a cross-sectional view of the utility access box of FIG. 2 taken along the line A-A.

FIG. 4 is a top view of the utility access box of FIG. 1.

FIG. 5 is a bottom perspective view of the utility access box of FIG. 1.

FIG. 6 is a top perspective view of two of the utility access boxes of FIG. 1 stacked one on top of another.

FIG. 7 is a side view of the stacked utility access boxes of FIG. 6.

FIG. 8 is a cross-sectional view of the stacked utility access boxes of FIG. 7 taken along line D-D.

FIG. 9 is a flow diagram illustrating a method for making a utility access box in accordance with an example embodiment.

FIG. 10 is a top perspective view of a reversible cover for a utility access box in accordance with an example embodiment.

FIG. 11 is a bottom perspective view of the reversible cover of FIG. 10.

FIG. 12 is a front elevational view of the reversible cover of FIG. 10.

FIG. 13 is a rear elevational view of the reversible cover of FIG. 10.

FIG. 14 is a left side elevational view of the reversible cover of FIG. 10.

FIG. 15 is a right side elevational view of the reversible cover of FIG. 10.

FIG. 16 is a top plan view of the reversible cover of FIG. 10.

FIG. 17 is a bottom plan view of the reversible cover of FIG. 10.

FIG. 18 is a perspective view of a utility access system including the reversible cover of FIG. 10.

FIG. 19 is a flow diagram of a method for installing a pedestal on a utility access vault using the reversible cover of FIG. 10.

FIG. 20 is a bottom perspective view of a utility access box including interior rim support embers in an example embodiment.

### DESCRIPTION

Example embodiments will now be described more fully hereinafter with reference to the accompanying drawings, in which the example embodiments are shown. The embodiments may, however, be implemented in many different forms and should not be construed as limited to the specific examples set forth herein. Rather, these embodiments are provided so that this disclosure will be thorough and complete. Like numbers refer to like elements throughout.

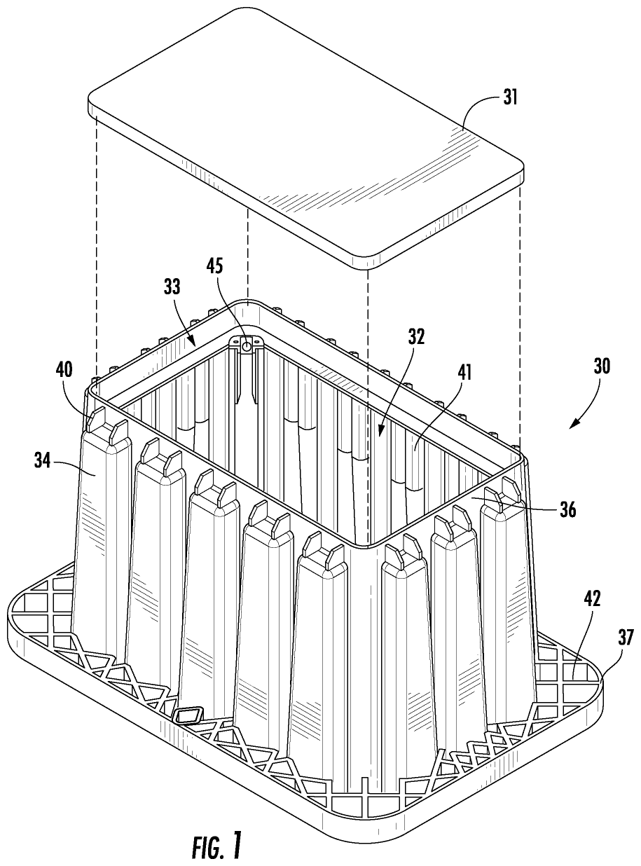

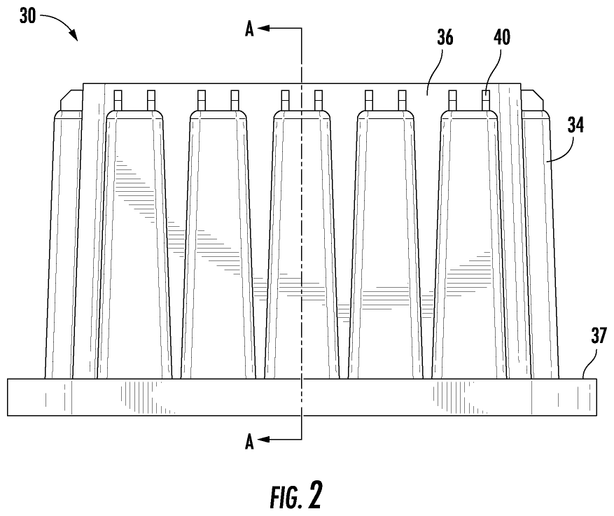

Referring initially to FIGS. 1-5, a utility access box or vault 30 in accordance with an example embodiment is first described. The box 30 is designed to be flush-mounted in the ground and receive a lid 31 in the top opening 32 illustrated in FIG. 1, which allows access to a cavity therein where the utility infrastructure is located (e.g., electrical wiring or components, telecommunications components, water/sewer components, traffic light components, meters, valves, etc.). Conventional lids 31 (e.g., polymer concrete, conventional concrete, etc.) may be used with the illustrated box 30, and in the illustrated configuration fits within the rimmed opening or rim 33 at the top of the box. As seen in FIG. 1, the lid 31 is sized to close the opening 32 when received by the rim 33.

Generally speaking, utility access boxes are positioned in locations where they may be subject to stress and heavy loads, such as along roadways. As such, they need to be sturdy enough to withstand such loads, which is why some of these boxes are made of concrete. However, transportation and storage of the boxes are also significant concerns, and thus lighter weight materials, such as polymer-based materials including high-density polyethylene (HDPE), are also used. A tiered scale is used to rate the strength of utility boxes, with tier 22 being the highest rating meant to withstand extreme loads such as being run over by a semi-tractor trailer.

The configuration of the illustrated box 30 provides a technical advantage of allowing fabrication from relatively light weight materials, such as HDPE (although other suitable materials may also be used, including concrete and polymer concrete or other polymer-based materials), while also providing enhanced structural stability high enough to achieve a tier 22 rating (although the present configuration may be used for lower-tiered box configurations as well). To achieve its structural rigidity, the box 30 illustratively includes outer (first) and inner (second) ribs 34, 35 along slanted or flared walls 36, with the first ribs extending outwardly away from the rim 33 and the second ribs extending inwardly toward the rim. In the present example, the exterior and interior ribs 34, 35 have a cross section resembling an elongated isosceles trapezoid (pyramids), although other shapes may be used in different embodiments (e.g., semi-cylindrical, triangular, etc.). As seen in FIGS. 1 and 5, the exterior and interior ribs 34, 35 alternate in an accordion-like or corrugated fashion, such that where the outer ribs protrude the inner ribs are recessed, and vice-versa. Moreover, the outer ribs 34 have their base (widest portion) at the bottom of the box 30, while the inner ribs 35 have their base at the top of the box (i.e., the exterior and interior ribs 34, 35 are inverted with respect to one another).

The sidewalls 36 of the box 30 extend vertically upward from a base 37 and are connected together to define the cavity therebetween and the opening 32 at a top of the box, with the rim 33 inside the opening. The exterior and interior ribs 34, 35 extend from the base 37 to the rim 33. More specifically, the exterior and interior ribs 34, 35 are in contact with and extend from the level of the base 37 all of the way up at least to the bottom level of the rim 33 in the illustrated example. Not only does this provide extra support and rigidity all of the way up the sides 36 of the box 30, but it also allows for extra reinforcement of the rim 33. Threaded inserts 45 or other suitable connectors may be included for securing the lid 31 (e.g., with screws, etc.).

In this regard, one or more exterior (first) fins 41 are positioned on the tops of the first ribs 34, and one or more interior (second) fins are carried on the interior fins 35. The exterior fins 40 are coupled to the sidewalls of the rim 33, while the interior fins 41 are coupled to the bottom of the rim, providing both lateral and vertical support to the rim when the cover 31 is under load. In the illustrated example, respective pairs of exterior fins 40 and interior fins 41 are carried by the exterior ribs 34 and interior ribs 35 for extra reinforcement and rigidity, although a single fin (or more than two fins) may be used on the exterior and/or interior in different embodiments. The ribs 34, 35 and fins 40, 41 advantageously provide desired structural stability or rigidity to help prevent excess deformity/bending of the box 30 under load, and achieve desired load ratings such as those noted above. Moreover, having the fins 40, 41 directly coupled to the ribs 34, 35 extends that structural stability to the rim 33 as well.

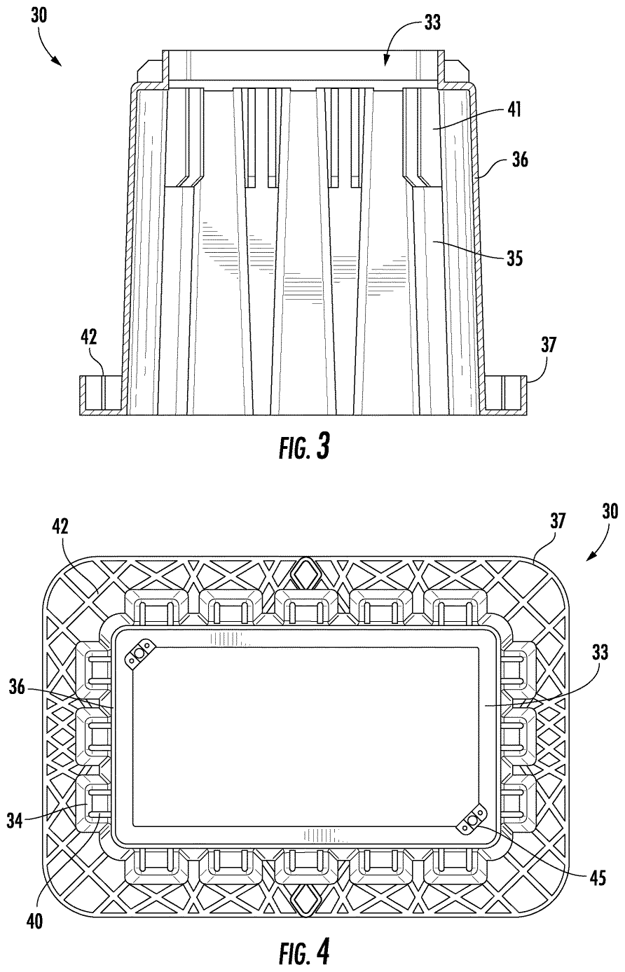

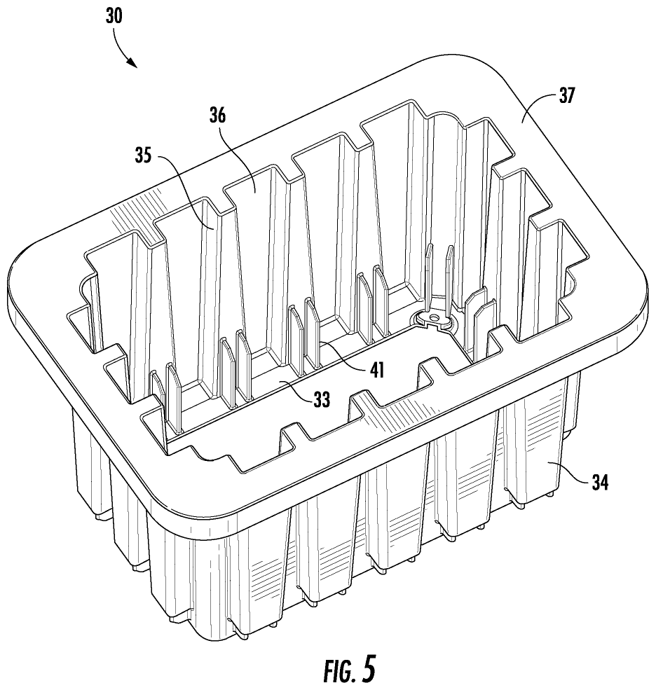

The base 37 of box 30 includes a webbed footer or footing 42 (FIG. 4), adding additional structural rigidity while helping to remove material to reduce weight. However, different footer configurations (e.g., solid, etc.) may also be used in different embodiments. It should be noted that the box 30 in the illustrated example is rectangular, but it may take other shapes (e.g., square, round, etc.) in different embodiments. Moreover, access boxes or vaults are known to come in a variety of different sizes for different applications, and the utility box described herein may be fabricated to accommodate such different sizes as well.

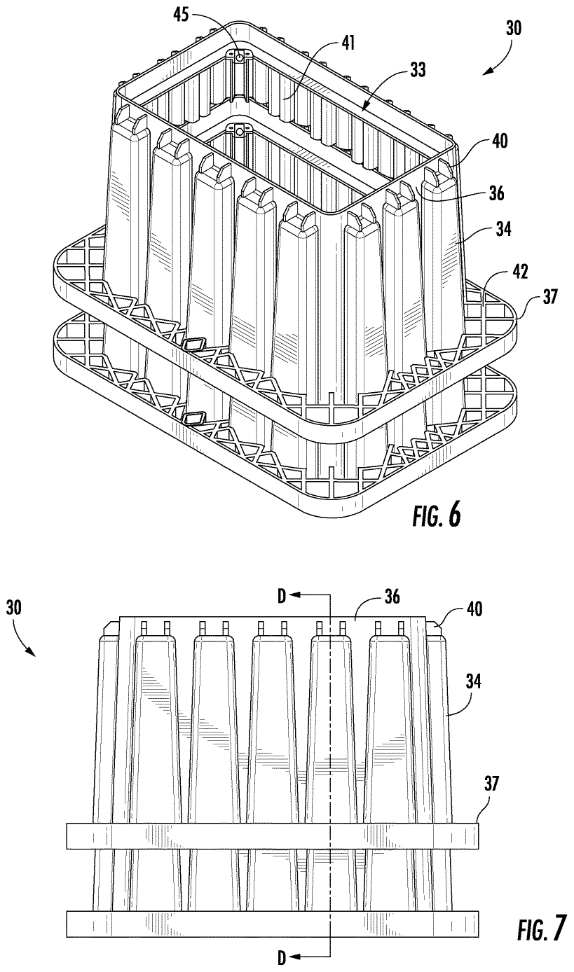

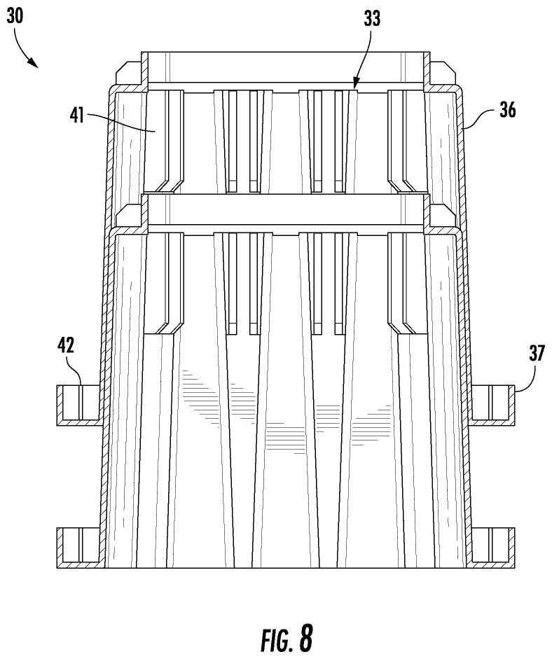

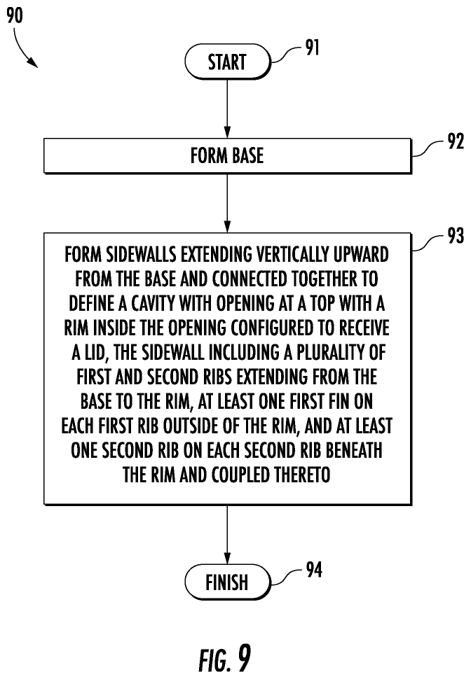

Another significant technical advantage of the utility box 30 is that it is a one-piece configuration which may be easily stacked for shipping and storage, as shown in FIGS. 6-8. The unitary, one-piece configuration is advantageous in that it requires less work to assemble in the field than a two-piece configuration, and may require less time to package for shipping. Moreover, less parts also reduces the chances of pieces getting lost or separated during shipping or storage, for example.

With regard to stacking, the flared walls 36 allow multiple boxes 30 to be stacked one on top of another as noted above. In addition, the interior fins 41 provide a stop that keeps the next box 30 in the stack from sliding all of the way down along the lower box, which allows the boxes to be more easily separated during unstacking. The above-described configuration, including the pyramid shape of the inner and outer ribs 34, 35, also helps provide a technical advantage of easier de-molding during the fabrication process, e.g., after injection molding.

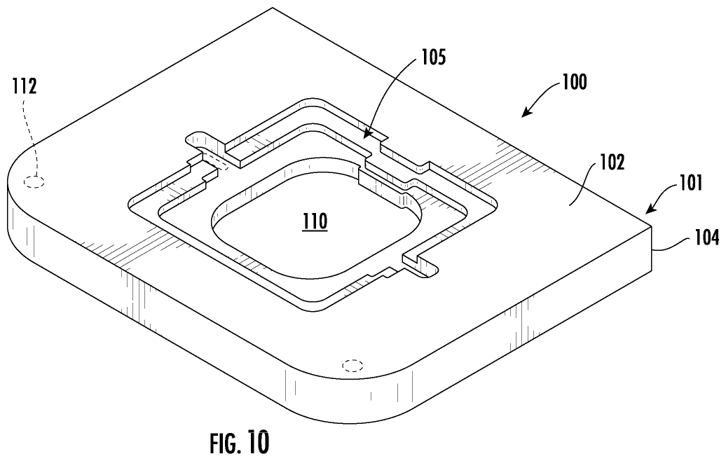

A related method for making the box 30 is now described with reference to the flow diagram 90 of FIG. 9. Beginning at Block 91, the method illustratively includes forming the base 37 and the plurality of sidewalls 36 extending vertically upward from the base, at Blocks 92-93. As discussed further above, the base 36 and sidewalls 36 may be integrally formed as a single, unitary body in a mold (e.g., from HPDE), although in some embodiments they could be formed as separate pieces. After demolding, the box 30 may be stacked with others for ease of storage and shipping, and its configuration allows for easy unstacking for deployment, as noted above. The method of FIG. 9 illustratively concludes at Block 94.

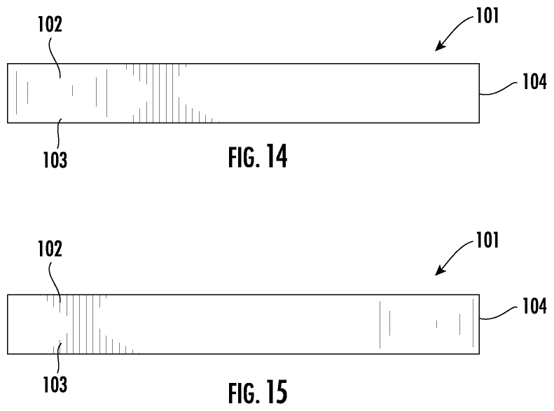

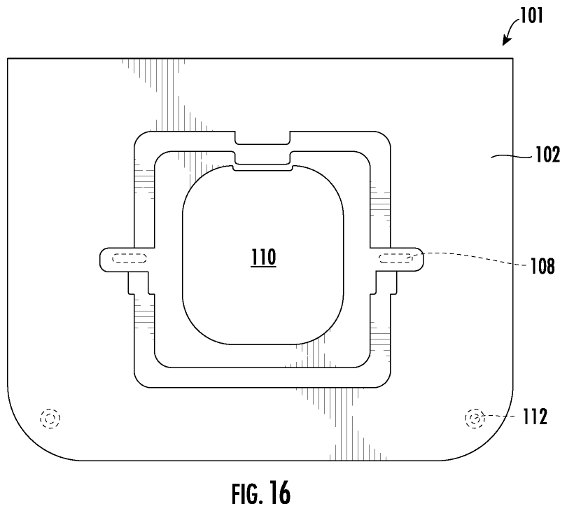

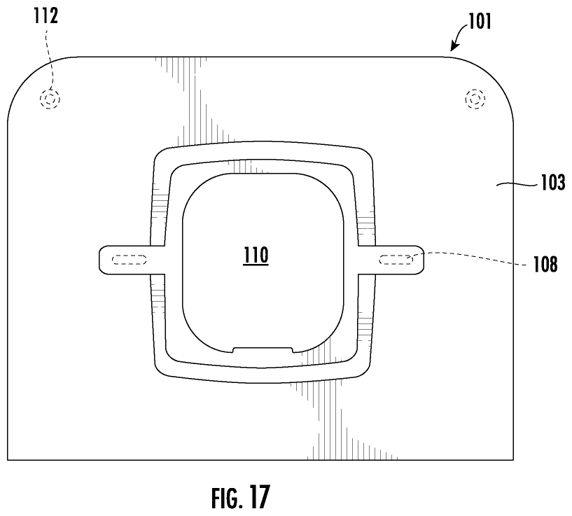

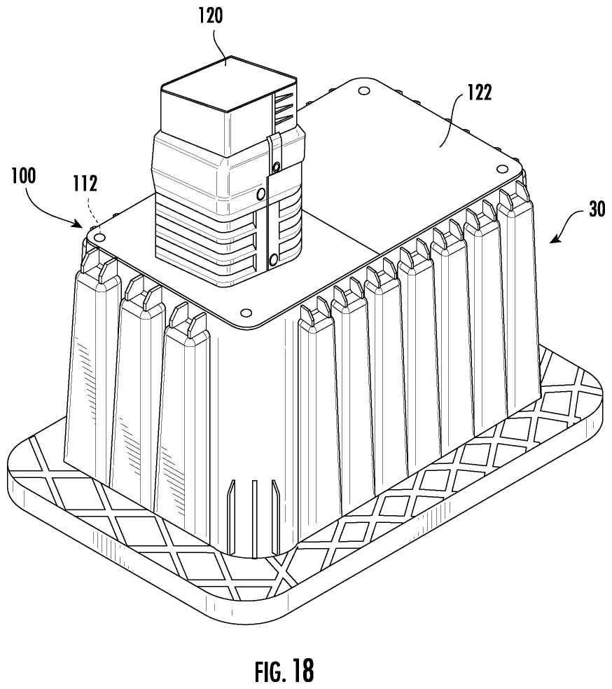

Turning to FIGS. 10-17, an example cover 100 which may be used with the above-described utility vault 30 (or other utility vaults) is now described. By way of background, utility access boxes and vaults such as those described above are commonly used in telecommunications and fiber optic network installations. In such applications, it is often necessary to mount equipment above ground at the access point. One common type of above-ground equipment is a pedestal, which is typically a sealed, weatherproof enclosure that houses telecommunications or fiber optic equipment such as splice trays, distribution terminals, network interface devices, and the like. Pedestals are manufactured by various companies, and different manufacturers use different mounting configurations and footprint dimensions for their pedestal designs.

In conventional installations, the top of the utility access box is installed flush with the ground, and a pedestal is mounted directly on top of the box or on a separate mounting plate or adapter that sits on top of the box. The pedestal typically has a base flange with a specific bolt pattern and dimensions that match the mounting surface. Because different pedestal manufacturers use different mounting configurations, a given mounting surface may only be compatible with pedestals from a single manufacturer or a limited range of models. This lack of interoperability presents significant challenges in the field, as installers and maintenance personnel need to ensure they have the correct mounting adapter or box configuration for the specific pedestal being used. If a pedestal needs to be replaced with one from a different manufacturer, the entire mounting infrastructure may need to be replaced or modified.

Moreover, inventory management and logistics become more complex when different mounting solutions are required for different pedestal types. Installers are required to carry multiple types of mounting adapters or covers, and distributors must stock various configurations to accommodate different customer needs. This increases costs and reduces flexibility in the field.

The reversible cover 100 provides a technical solution to these interoperability challenges, as it is designed to accept pedestals from multiple manufacturers, with different mounting configurations provided on opposite sides of the cover. By simply flipping the cover 100 over, an installer can switch between two different pedestal mounting configurations without needing to change any other components. This reversible design significantly enhances the versatility and utility of access box systems, reduces the number of different parts that need to be stocked and carried in the field, and simplifies installation and maintenance operations.

In the illustrated example, the cover 100 is sized and configured to be received by the rim 33 of the utility access box 30 described above (or other similarly configured utility access boxes), and provides a mounting surface for above-ground pedestals. As will be described in greater detail below, the cover 100 is reversible, meaning it can be installed in either of two orientations to accommodate different types or configurations of pedestals (e.g., from different manufacturers).

The cover 100 illustratively includes a generally rectangular body 101 having a first (top) side 102 and a second (bottom) side 103, although other shapes (e.g., square, circular, etc.) may be used in different embodiments to match the shape of the underlying utility access box. The first and second sides 102, 103 have respective first and second mounting patterns 105, 106. Generally speaking, the second mounting pattern 106 may have a different number of inserts, different spacing, and/or different arrangement compared to the first mounting pattern 105, as will be discussed further below. The body 101 has a cable opening 110 therein, and the first and second mounting patterns are positioned around (e.g., centered on) the cable opening. Cabling may be routed between the utility access box 30 and the pedestal via the cable opening 110.

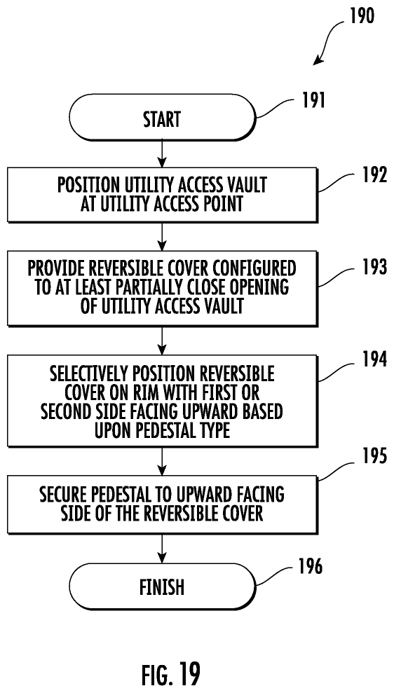

The body 101 includes a peripheral rim portion 104 that rests on the rim 33 of the utility access box 30 when the cover 100 is installed. Screw/bolt holes or channels 112 may be provided for attaching the body 101 to the rim 33, as shown in FIG. 18. A pedestal 120 is attached to the cover 100, as will be discussed further below, and in the illustrated example a second, flat half-cover 122 covers the remainder of the box opening (although in some embodiments the covers 100 and 122 may be formed as a unitary piece/cover, if desired). In the illustrated example, the body 101 is substantially planar, although in some embodiments the body may have a slightly domed or crowned upper surface to facilitate water drainage.

The first side 102 of the cover 100 includes a first mounting pattern 105 configured to receive a pedestal from a first manufacturer or first group of manufacturers. The first mounting pattern 105 illustratively includes a plurality of threaded inserts, mounting holes, or other fastener receptacles arranged in a specific pattern (e.g., bolt circle diameter, hole spacing, etc.) that corresponds to the base flange of pedestals from the first manufacturer. In the illustrated embodiment, the first mounting pattern 105 is configured to accommodate pedestals from Charles Industries, including the BDO series fiber splice pedestals, as well as compatible pedestals from Vertiv. These pedestals typically have a standardized mounting footprint that is widely used in the telecommunications industry.

The second side 103 of the cover 100 includes a second mounting pattern 106 configured to receive a pedestal from a second manufacturer or second group of manufacturers. The second mounting pattern 106 is different from the first mounting pattern 105, having a different arrangement of fastener receptacles, different dimensions, or different spacing to accommodate the mounting requirements of pedestals from the second manufacturer. In the illustrated embodiment, the second mounting pattern 106 is configured to accommodate Coyote series pedestals from PLP (Preformed Line Products), including the 6-inch, 8-inch, and 10-inch Coyote pedestal models. The Coyote pedestal series uses a different mounting configuration than the Charles Industries/Vertiv pedestals, with different bolt patterns and base dimensions.

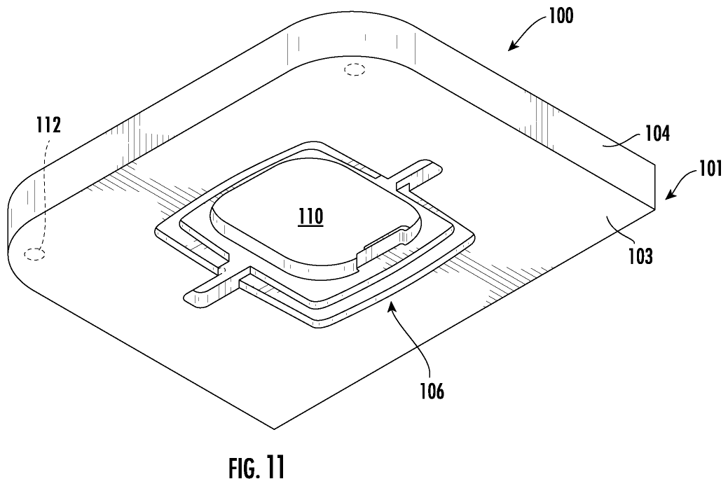

As best seen in FIGS. 10 and 11, the first and second mounting patterns 105, 106 are positioned on opposite sides of the cover 100, allowing the cover to be reversible. When the cover 100 is installed with the first side 102 facing upward, pedestals compatible with the first mounting pattern 105 can be secured to the cover. When installation or replacement of a pedestal requires a different mounting configuration, the cover 100 can simply be removed, flipped over, and reinstalled with the second side 103 facing upward, thereby exposing the second mounting pattern 106 for use with pedestals compatible with that configuration. This eliminates the need to stock and install different adapter plates or covers for different pedestal types.

The cover 100 may be fabricated from various materials suitable for outdoor use and capable of supporting the weight and loads associated with pedestal installations. In some embodiments, the cover 100 comprises high-density polyethylene (HDPE), polymer concrete, fiberglass-reinforced polymer, or other durable polymer-based materials, for example. In other embodiments, metal or other suitable materials may be used. The material and thickness of the cover 100 are selected to provide adequate structural support for the mounted pedestal while remaining light enough for convenient handling and installation by a single technician. In the illustrated example, the cover 100 is a unitary, one-piece construction, although in some embodiments the cover could be formed from multiple pieces or layers that are bonded or otherwise secured together.

In some embodiments, the body 101 of the cover 100 may include structural reinforcement features to ensure adequate strength and rigidity when supporting a pedestal. For example, the body 101 may include a network of ribs or other reinforcing structures (not shown) extending across the underside of the cover. Such features may help provide additional stiffness and distribute loads across the cover while minimizing material usage and weight. Ribs, etc., may be arranged in a grid pattern, radial pattern, or other configuration optimized for load distribution, as will be appreciated by those skilled in the art.

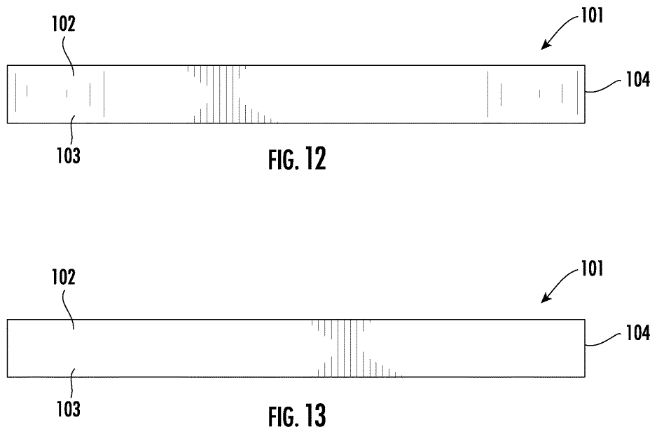

As seen in FIGS. 12-15, in the illustrated example the cover 100 has a substantially uniform thickness. The peripheral rim portion 104 is sized to fit securely within or on top of the rim 33 of the utility access box 30, providing a stable mounting surface for the pedestal while maintaining the weather-resistant seal of the utility box below. In some embodiments, a gasket or sealing element (not shown) may be provided between the cover 100 and the rim 33 to enhance the seal and prevent water infiltration.

Slots 108 are arranged on opposite sides of the first and second mounting patterns 105, 106. The slots 108 are configured to receive bolts or screws that extend through mounting holes in the base flange of the pedestal, thereby securing the pedestal to the cover 100. In some embodiments, one or both of the mounting patterns 105, 106 may include additional features such as alignment pins, locating tabs, or registration features to assist in properly positioning the pedestal during installation.

The reversible cover 100 provides significant advantages over conventional pedestal mounting solutions. By incorporating two different mounting patterns on opposite sides of a single cover, the design eliminates the need for separate adapter plates or multiple cover types to accommodate different pedestal manufacturers. This reduces inventory requirements, simplifies logistics, and provides installers with greater flexibility in the field. If a pedestal needs to be replaced with a different manufacturer's model, the cover can simply be flipped rather than requiring a complete replacement of the mounting infrastructure. The design also future-proofs installations, as a site equipped with the reversible cover 100 can readily accept pedestals from either of the supported manufacturer groups without additional modification.

It should be noted that while the illustrated embodiment is configured to accommodate pedestals from two specific groups of manufacturers (Charles Industries/Vertiv on one side, and PLP Coyote series on the other), the reversible cover concept can be adapted to accommodate other combinations of pedestal types in different embodiments. For example, different covers could be manufactured with different pairs of mounting patterns to accommodate other manufacturer combinations as needed. Additionally, while the illustrated embodiment shows circular or arcuate mounting patterns, other configurations such as rectangular, linear, or irregular patterns could be used depending on the specific pedestal designs being accommodated.

In use, the reversible cover 100 is selected based on the types of pedestals that may be used at a particular installation site. The cover 100 is oriented with the appropriate side facing upward based on the pedestal to be installed initially. The cover 100 is then positioned on the rim 33 of the utility access box 30, and the pedestal is mounted to the exposed mounting pattern using appropriate fasteners. The pedestal is thereby securely mounted in position above the utility access box 30, with cables or other utilities passing through the box 30 and up into the pedestal as needed. If the pedestal later needs to be replaced with a model from a different manufacturer that requires a different mounting pattern, the existing pedestal is removed, the cover 100 is removed and flipped to expose the alternate mounting pattern, the cover is reinstalled, and the new pedestal is mounted to the now-exposed mounting pattern. This simple reversal operation avoids the need to replace or modify the mounting infrastructure.

The reversible pedestal cover 100 may be used with the utility access box 30 described earlier in this specification, taking advantage of the structural strength and stackability features of that box design. However, the reversible cover 100 may also be used with other types of utility access boxes, vaults, or pull boxes, provided the cover is appropriately sized to fit the opening of the particular box being used. The modular nature of the cover design allows it to be readily adapted to different box sizes and shapes by scaling the dimensions of the cover body 101 and adjusting the position of the peripheral rim portion 104 accordingly.

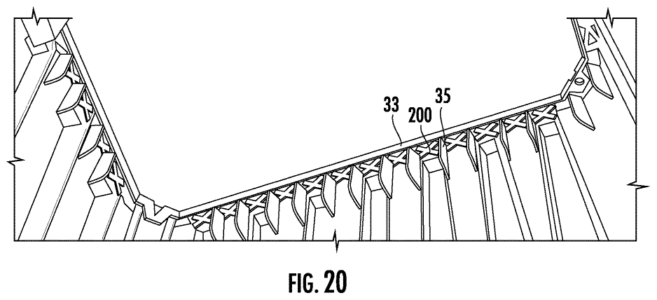

A related method for installing a pedestal on a utility access vault is now described with reference to the flow diagram 190 of FIG. 19. The method begins (block 191) with positioning the utility access vault 30 (or other suitable vault) at a utility access point (block 192), as discussed above. The method further illustratively includes providing the reversible cover 100 (block 193) and selectively positioning the reversible cover on the rim 33 with either the first side 102 facing upward to expose the first mounting pattern 105, or the second side 103 facing upward to expose the second mounting pattern 106 based upon the pedestal being of the first or second pedestal type, respectively (block 194), and securing the pedestal to the upward facing side of the reversible cover (block 195), as also discussed further above. The method of FIG. 19 illustratively concludes at block 196.

Turning to FIG. 20, in some embodiments additional interior support members 200 may be positioned on or along interior surfaces of the box 30 to support the rim 33. In the illustrate example, the interior support members 200 are X-shaped ribs that are coupled between adjacent interior ribs 35 and support the rim 33. However, it will be appreciated that different support members (e.g., a single rib, etc.) may be used in different embodiments. The interior support members 200 may also provide deflection support, to help keep the rim 33 from deflecting from ground pressure. In this regard, the interior support members 200 may be vertically spaced or offset from the rim 33 in some embodiments.

Many modifications and other embodiments of the invention will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A utility access system comprising:
a utility access vault having a base, a plurality of sidewalls extending vertically upward from the base and connected together to define a cavity therein with an opening at a top thereof and a rim inside the opening; and
a reversible cover configured to at least partially close the opening when received by the rim;
wherein the reversible cover comprises a body having a first side and a second side, the first side including a first mounting pattern corresponding to a first pedestal type, and the second side including a second mounting pattern corresponding to a second pedestal type, the second mounting pattern being different from the first mounting pattern;
wherein the reversible cover is selectively positionable with either the first side facing upward to expose the first mounting pattern or the second side facing upward to expose the second mounting pattern.

2. The utility access system of claim 1 wherein the body has a cable opening therein, and wherein the first and second mounting patterns are positioned around the cable opening.

3. The utility access system of claim 2 wherein the first and second mounting patterns are centered on the cable opening.

4. The utility access system of claim 1 wherein the body of the reversible cover comprises a peripheral rim portion configured to rest on the rim of the utility access vault.

5. The utility access system of claim 1 wherein the body of the reversible cover comprises a unitary body.

6. The utility access system of claim 1 wherein the reversible cover comprises high-density polyethylene (HDPE).

7. The utility access system of claim 1 wherein each of the sidewalls of the utility access vault comprises a plurality of first and second ribs extending from the base to the rim, the first ribs extending outwardly away from the rim and the second ribs extending inwardly toward the rim.

8. The utility access system of claim 7 wherein the first and second ribs are arranged in an alternating fashion along each sidewall.

9. The utility access system of claim 7 wherein the first and second ribs comprise elongated isosceles trapezoids.

10. The utility access system of claim 1 wherein the utility access vault comprises a plurality of interior support members coupled between interior surfaces of the utility access vault and a bottom of the rim.

11. A reversible pedestal cover for a utility access vault comprising:
a body having a first side and a second side and comprising a peripheral rim portion configured to rest on a rim of the utility access vault;
a first mounting pattern on the first side of the body corresponding to a first pedestal type; and
a second mounting pattern on the second side of the body and corresponding to a second pedestal type, the second mounting pattern being different from the first mounting pattern;
wherein the body is reversible to selectively expose either the first mounting pattern or the second mounting pattern.

12. The reversible pedestal cover of claim 11 wherein the body has a cable opening therein, and wherein the first and second mounting patterns are positioned around the cable opening.

13. The reversible pedestal cover of claim 12 wherein the first and second mounting patterns are centered on the cable opening.

14. The reversible pedestal cover of claim 11 wherein the body comprises a unitary body.

15. The reversible pedestal cover of claim 11 wherein the body comprises high-density polyethylene (HDPE).

16. A method for installing a pedestal on a utility access vault comprising:
positioning the utility access vault at a utility access point, the utility access vault having a base, a plurality of sidewalls extending vertically upward from the base and connected together to define a cavity therein to cover the utility access point and with an opening at a top thereof and a rim inside the opening;
providing a reversible cover configured to at least partially close the opening, the reversible cover comprising a body having a first side and a second side, the first side including a first mounting pattern corresponding to a first pedestal type, and the second side including a second mounting pattern corresponding to a second pedestal type, the second mounting pattern being different from the first mounting pattern;
selectively positioning the reversible cover on the rim with either the first side facing upward to expose the first mounting pattern or the second side facing upward to expose the second mounting pattern based upon the pedestal being of the first or second pedestal type, respectively; and
securing the pedestal to the upward facing side of the reversible cover.

17. The method of claim 16 wherein the body has a cable opening therein, and wherein the first and second mounting patterns are positioned around the cable opening.

18. The method of claim 17 wherein the first and second mounting patterns are centered on the cable opening.

19. The method of claim 16 wherein the body of the reversible cover comprises a peripheral rim portion configured to rest on the rim of the utility access vault.

20. The method of claim 16 wherein the body of the reversible cover comprises a unitary body.
